(19) United States
(12) Patent Application Publication
(10) Pub. No.: US 2026/0218320 A1
(43) Pub. Date: Jul. 30, 2026

(54) METHOD FOR PROCESSING HIDES AND FABRICS

(71) Applicant: RENBERTECH S.R.L., TRISSINO (VICENZA) (IT)

(72) Inventor: Renato BERTOLI, CHIAMPO (VICENZA) (IT)

(73) Assignee: RENBERTECH S.R.L., TRISSINO (VICENZA) (IT)

(21) Appl. No.: 18/874,629

(22) PCT Filed: Jun. 13, 2023
(86) PCT No.: PCT/EP2023/065752

§ 371 Date: Dec. 13, 2024

(30) Foreign Application Priority Data
Jun. 15, 2022 (IT) 102022000012671

(51) Int. Cl. C14C 9/02; C14C 1/04; D06P 3/32

(52) U.S. Cl. CPC C14C 9/02; C14C 1/04; D06P 3/32

(57) ABSTRACT

A method for processing hides, fabrics or the like, including the steps of:
wetting the hides, covering them with a predetermined amount of cold water;
soaking the hides, treating them with one or more soaking and degreasing agents;
retanning the hides, treating them with one or more retanning agents;
neutralizing the hides, treating them with one or more neutralizing agents;
dyeing the hides, treating them with one or more dyeing agents;
fatliquoring the hides, treating them with one or more fatliquoring agents.

The steps of wetting, soaking, retanning, neutralizing, dyeing and fatliquoring the hides are carried out in a controlled-atmosphere environment, which is thermally insulated from the surrounding environment; predetermined temperature and/or humidity conditions are generated and maintained within the controlled-atmosphere environment.

The present invention relates to a method for processing hides, fabrics, and the like.

As is known, animal hides are converted into leather by tanning, an operation that makes the fibers imputrescible.

The tanning process is quite lengthy and is performed through several steps, substantially including the preparation of the hide and the actual tanning.

Preparatory operations for tanning essentially serve to rid the hide of all those substances, hair, epidermis, fatty layer, etc., that will not be transformed into leather.

These preparatory operations constitute the so-called beamhouse operations and fundamentally include: soaking, unhairing, liming, fleshing, splitting, deliming, bating and degreasing.

After beamhouse operations, however, the hide is still putrescible and must therefore be subject to the actual tanning.

During tanning, the fibers of the hide are impregnated with chemical substances that are irreversibly fixed to it and convert the putrescible hide into an imputrescible material, i.e., leather.

However, the tanned hide is not yet usable for producing articles, because it is constituted by a wet material that even if dried, it would result in a product with a rather stiff and cardboard-like consistency, and with the typical color of the tanning with which it was obtained: this is so-called “wet white” or “wet blue” hide.

Therefore, the tanned hide, in order to turn into a marketable product useful for the production of articles, must undergo additional chemical and mechanical treatments that impart certain characteristics to the leather.

These treatments, commonly known as “retanning”, essentially include: actual retanning, neutralization, dyeing and fatliquoring.

Before tackling these further processing steps, the hides are shaved, i.e., brought to the same thickness, and weighed to calculate the amount of water and chemical products to be used.

Retanning operations are generally carried out using machines known as drums, which are essentially constituted by large hermetic containers that, with their rotary motion, promote the penetration of the chemical products into the hide.

Inside the drums, special pegs, or shelves, drag the hides upward during rotation and then make them fall so that they can be immersed in the mixture of water and chemical products contained in the drums.

The retanning steps described above require considerable amounts of water and chemical products, liquids and powders that must be mandatorily disposed of in a purification plant, often resorting to additional chemical products and to more water to ensure a quality that meets current regulations.

In this regard, a retanning cycle of the traditional type requires on average a water use ranging from 1000% to 2000% by weight of the shaved hides.

The percentage values related to water discharge are also substantially between 1000% and 2000% by weight of the shaved hides, and all the discharged water must be transferred to purification.

As regards the chemical products used, they are used in quantities greater than 20% by weight on the weight of the shaved hides.

Also, it should be noted that at the end of the various steps, the hides are wet and require a drying process, with consequent high-energy consumption and atmospheric emissions.

CN110938717A discloses a manufacturing method of white anti-yellowing cow split leather wherein wet blue leather is sequentially subjected to rewetting, primary retanning, alkali extraction, secondary retanning, primary dyeing, main fatliquoring, secondary dyeing, plate pasting, drying, softening, buffing and drum milling.

CN107938392A discloses a leather retanning dyeing process for reducing dye residue in dyeing wastewater wherein dyeing aids are combined with the amino resin modified collagen for one-bath dyeing. The dyes can be relatively completely absorbed by leather fibers, then dye molecule residues in wastewater are reduced, and the dye wastewater after treatment difficulties are reduced.

US2017/233833A1 discloses a process for leather production from a raw animal hide, using waste liquids. The process includes the steps of pre-soaking, soaking, unhairing and liming, re-liming, deliming and bating, pickling and tanning, degreasing, retanning, neutralizing, dyeing and fatliquoring, and washing the processed hide. The collected waste liquid can be recycled to the same step, to a different step, or to two of more steps in the process.

The aim of the present invention is to provide a method for processing hides, fabrics and the like, that overcomes the drawbacks of the cited prior art.

Within the scope of this aim, a particular object of the invention is to provide a method that makes the hide processing operations more sustainable, by decreasing the use of water, chemical products and energy used.

A further object of the invention is to provide a method that allows to perform the so-called “wet” steps of hide processing without using any bath, contrary to the conventional processes.

A further object of the invention is to provide a method that allows a considerable reduction of the wastewater to be purified.

A further object of the invention is to provide a method that substantially reduces emissions.

A further object of the invention is to provide a highly efficient method that substantially reduces the cost of the final product.

This aim and these objects, as well as others that will become better apparent hereinafter, are achieved by a method for processing hides and fabrics, as claimed in the appended claims.

Further characteristics and advantages will become better apparent from the description of a preferred but not exclusive embodiment of a method for processing hides, fabrics or the like, illustrated by way of non-limiting example in the accompanying drawings, wherein:

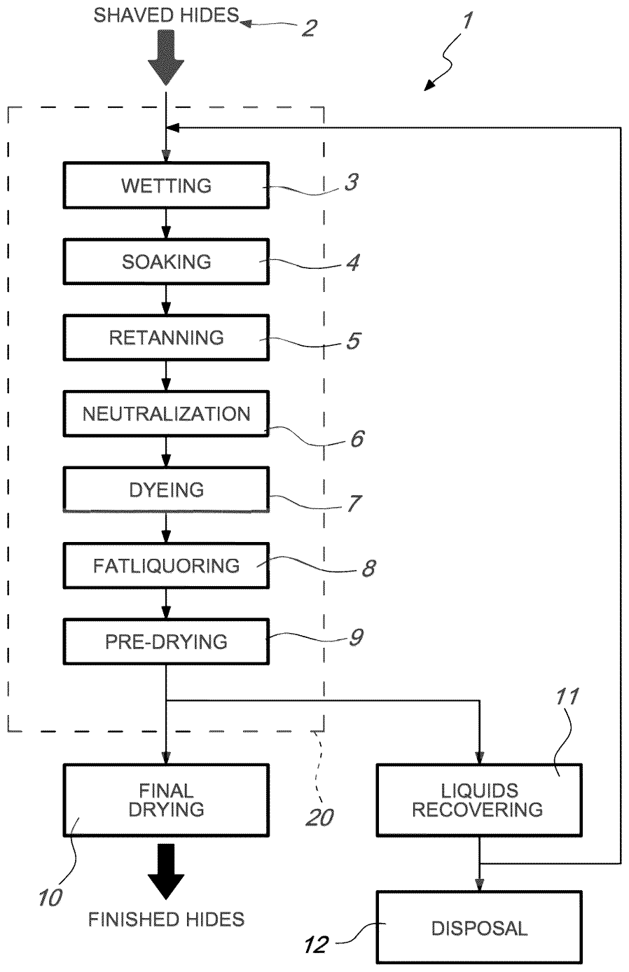

FIG. 1 is a block diagram showing the steps of the method according to the invention.

With reference to the cited figure, the method for processing hides, fabrics or the like, according to the invention, generally designated by the reference numeral 1, has considerable flexibility of use; however, it is particularly suitable for the processing of hides 2 that are shaved and preferably already tanned.

Before starting the process, the hides 2 are weighed, with the main purpose of determining the amount of water and of the various chemical agents to be used in carrying out the various processing steps.

The proportions between the weight of the hides 2, the amount of water, and the amount of chemical agents, may vary depending on various aspects; the amounts are kept within particularly low values with respect to the prior art, as better defined hereinafter.

The method 1 includes a step 3 of wetting the hides 2. The hides are sprayed with cold water. The wetting step 3 is followed by a soaking step 4, during which the hides 2 are treated with soaking and degreasing agents. The method includes a further retanning step 5 for retanning the hides 2, which are treated with retanning agents.

In the present context, the term “cold water” generally means water that is not heated.

The steps of soaking 4 and retanning 5 respectively have the purpose of cleaning the hides 2 from the coarser dirt and improving their aesthetics by filling in their voids, so as to give the hides the desired fullness and compactness.

The hides 2 are then subjected to a neutralization step 6, during which the hides are treated with neutralizing agents that bring the hides 2 to a pH value that is optimal for the penetration and fixation of the chemical agents used later.

The neutralization step 6 is followed by a dyeing step 7, during which dyeing agents are applied to the hides 2.

The hides 2 are then subjected to a fatliquoring step 8, in which they are treated with fatliquoring agents that substantially “lubricate” the internal fibrous structure of the hides, giving them special organoleptic properties.

The steps of the method 1 preferably occur in the sequence described above.

It is important to note, however, that the steps described above may also follow one another in a different order, or some of the steps indicated as separate might in practice be grouped together, without thereby abandoning the scope of the invention.

According to the present invention, at least the above-mentioned steps of wetting 3, soaking 4, retanning 5, neutralizing 6, dyeing 7 and fatliquoring 8 of the hides 2 take place within a controlled-atmosphere environment 20 that is thermally insulated from the surrounding environment.

In greater detail, the controlled-atmosphere environment 20 is substantially an environment within which predetermined temperature and/or humidity conditions can be generated and maintained.

Advantageously, such a controlled-atmosphere environment 20 is formed, for example, by a climate-controlled chamber, which is substantially hermetic and thermally insulated from the external environment, and into which the hides 2 are fed to perform the various processes described.

This chamber preferably includes a perforated inner wall and an insulated outer wall that is hermetically closed except for an opening for loading/unloading the hides 2.

The present method is advantageously practiced by using a machine, not shown in the drawings, which includes a structure supporting a substantially cylindrical thermally insulated tub which in practice forms the controlled-atmosphere environment 20. A perforated basket, containing the hides 2, is rotatably mounted inside the tub and is rotated by an electric motor. The tub and the basket are provided with respective loading/unloading aligned openings provided with doors.

Preferably, the machine is equipped with an air treatment unit which, also with the aid of dedicated software, allows to generate and maintain an optimal temperature and/or humidity conditions for the execution of the method inside the tub.

According to the present method, the water, the soaking and degreasing agents, the retanning agents, the neutralizing agents, the dyeing agents, and the fatliquoring agents, are dosed inside the controlled-atmosphere environment 20 by means of adapted devices capable of nebulizing/atomizing these products, which are therefore diffused in the form of droplets, i.e., in the form of aerosols, so as to allow and promote a uniform and cohesive absorption of the agents by the hides 2.

The present invention allows to avoid immersing the hides 2 in treatment baths, contrary to conventional prior art methods, thus considerably reducing the use of water and chemical products, in contrast to the prior art.

The method according to the present invention uses an amount of cold water smaller than or equal to 100% by weight on the weight of the hides 2, and an amount of chemical products lower than or equal to 20% by weight on the weight of the same hides 2.

According to a further aspect of the invention, the fatliquoring step 8 is followed by a pre-drying step 9, during which the amount of residual humidity of the hides 2 is lowered to a target percentage.

In this regard, experimental tests conducted by the Applicant and careful analysis of the results have demonstrated that the hides 2, after the pre-drying step 9, can have an amount of water that is lower than 20% by weight on their initial weight.

Advantageously, the pre-drying step 9 is performed by controlling the temperature and/or humidity of the controlled-atmosphere environment 20, where “control” means the possibility to measure and adjust the temperature and/or humidity in that environment by acting on the corresponding parameters.

The hides 2 are then extracted from the controlled-atmosphere environment 20 and spread out on beams for the final drying step 10.

According to a further aspect of the invention, at least some of the vapors generated within the controlled-atmosphere environment 20 during the execution of the method 1 are condensed and recovered in the form of liquid in a step 11.

This liquid, together with the liquid used initially to soak the hides 2, is collected and purified, for example by filtration and decantation, in such a way that it can be at least partially recycled within the same method 1 or in a subsequent one.

In particular, the recovered liquid can be used for example to dilute the chemical products used in the method 1 or to soak other hides intended for a subsequent treatment.

In this way, only a minimal amount of the water of the aqueous solution used during the method 1 is then disposed of at civil wastewater treatment plants 12.

In practice it has been found that the invention achieves its intended aim and objects, providing a method for processing hides, fabrics and the like that makes the leather processing operations, that commonly fall under the name of retanning, decidedly more sustainable.

In fact, as shown, the method according to the invention allows to decrease the use of water, chemical products and energy used.

In particular, by using water and chemical products that are nebulized/atomized in droplet form, i.e., in aerosol form, the method according to the invention achieves the important advantage of avoiding the use of treatment baths to perform the wet steps of hide processing.

Moreover, the method according to the invention allows to considerably reduce the wastewater to be purified and to substantially reduce the atmospheric emissions resulting from it.

Also, all the chemical products used in the method according to the invention are natural and chemically related to leather.

The method according to the invention entails substantial savings in economic terms and at the same time allows to safeguard the environment and the health of workers.

This application claims the priority of Italian Patent Application No. 102022000012671, filed on Jun. 15, 2022, the subject matter of which is incorporated herein by reference.

1-10. (canceled)

11. A method for processing hides and fabrics, comprising the steps of:
wetting said hides, covering them with a predetermined amount of cold water;
soaking said hides, treating them with one or more soaking and degreasing agents;
retanning said hides, treating them with one or more retanning agents;
neutralizing said hides, treating them with one or more neutralizing agents;
dyeing said hides, treating them with one or more dyeing agents;
fatliquoring said hides, treating them with one or more fatliquoring agents;
said method comprising said steps of wetting, soaking, retanning, neutralizing, dyeing and fatliquoring said hides are carried out in a controlled-atmosphere environment, which is thermally insulated from the surrounding environment; predetermined temperature and/or humidity conditions being generated and maintained within said controlled-atmosphere environment.

12. The method according claim 11, wherein it comprises the step of pre-drying said hides, controlling at least the temperature and/or humidity of said controlled-atmosphere environment.

13. The method according claim 11, wherein said water, said soaking and degreasing agents, said retanning agents, said neutralizing agents, said dyeing agents, and said fatliquoring agents are dosed into said controlled-atmosphere environment by a nebulization/atomization means adapted to diffuse said water and said agents in droplet form, or in aerosol form, allowing and facilitating their uniform and cohesive absorption by said hides.

14. The method according claim 11, wherein the amount of water used to wet said hides is lower than or equal to 100% by weight on the weight of the shaved hides.

15. The method according claim 11, wherein the amount of said soaking and degreasing agents, said retanning agents, said dyeing agents, said fatliquoring agents and said neutralizing agents used to treat said hides is lower than or equal to 20% by weight on the weight of the shaved hides.

16. The method according claim 11, wherein at least part of the vapors generated in said controlled-atmosphere environment during said process are condensed and recovered in liquid form.

17. The method according claim 11, wherein said liquid is collected and purified so that it can be at least partially reused in said method or in a subsequent method.

18. The method according claim 11, wherein said controlled-atmosphere environment is formed within a climate-controlled chamber, which is substantially hermetic and thermally insulated from the external environment, into which said hides are fed in order to carry out the processes provided by said method; said chamber comprising a perforated inner wall and an outer insulating wall which is closed hermetically except for an opening for loading/unloading said hides.

19. The method according claim 11, wherein said chamber is provided within a substantially cylindrical thermally insulated tub supported by a supporting structure; a perforated basket for said hides being rotatably mounted within said tub; said basket being rotatable about a corresponding axis by virtue of a motor means; said tub and said basket being provided with respective loading/unloading openings, which are substantially aligned with each other; at said loading/unloading openings there being adapted doors; an air treatment unit being adapted to generate and maintain predetermined temperature and/or humidity conditions within said tub.

20. The method according claim 11, wherein the pre-dried hides are taken from said controlled-atmosphere environment and are spread out on beams for final drying.
